(19) United States
(12) Patent Application Publication
(10) Pub. No.: US 2015/0003244 A1
(43) Pub. Date: Jan. 1, 2015

(54) APPARATUS AND METHOD FOR PROVIDING RED IN PACKET SWITCHED NETWORK

(71) Applicant: Huawei Technologies Co., Ltd., Shenzhen (CN)

(72) Inventor: Ronen Hadar, Shenzhen (CN)

(21) Appl. No.: 14/488,010

(22) Filed: Sep. 16, 2014

Related U.S. Application Data
(63) Continuation of application No. PCT/EP2012/076641, filed on Dec. 21, 2012.

(51) Int. Cl. H04L 12/823

(52) U.S. Cl. CPC H04L 47/326
USPC 370/230

(57) ABSTRACT

An apparatus for providing a random early detection (RED) in a packet switched network, comprising: a dequeue counter which is incremented upon each dequeue of a data packet from a queue (Q), and which is reset upon each enqueue of a data packet into the Q; a coefficient memory table (CMT), which stores a predetermined number M of decay coefficients (C); and a calculation unit which is adapted to calculate upon each enqueue of a data packet in the Q, an average queue size (AQS), of the Q, depending on a decay coefficient (C) read from a memory address of the CMT to which the dequeue counter points before it is reset.

### CROSS-REFERENCE TO RELATED APPLICATIONS

This application is a continuation of International Application No. PCT/EP2012/076641, filed on Dec. 21, 2012, which is hereby incorporated by reference in its entirety.

### TECHNICAL FIELD

The present application relates to an apparatus and a method for providing a random early detection in a packet switched network.

### BACKGROUND

A random early detection (RED) is a mechanism to avoid traffic congestion in a packet switched network. The conventional RED mechanism, also known as random early discard or random early drop mechanism, is an active queue management algorithm. With the RED mechanism data can be dropped randomly prior to a congestion build-up. The probability for a packet drop is increased as data congestion gets higher. The RED mechanism can monitor an average queue size (AQS) and drop data packets based on statistical probabilities. For example, if a buffer is almost empty all incoming data packets are accepted. As the queue (Q) of data packets in the buffer grows the probability for dropping an incoming data packet is also increased. If the buffer is full the probability becomes 100% and all incoming data packets are dropped. The AQS is recalculated for every received data packet. However, in a conventional RED mechanism of a packet switched network the calculation of the AQS takes into account only an input function of the received data but not an output function, i.e. the conventional RED mechanism only takes into account the enqueuing of incoming data packets in the Q but not dequeue of data packets from the respective queue. Consequently, the conventional RED method used in a packet switched network does only show a limited ability to predict data congestion and to avoid such data congestion in the network.

Accordingly, there is a need to provide an apparatus and a method able to predict data congestion in a packet switched network accurately and to provide better data congestion avoidance.

### SUMMARY

The present application provides as a first aspect an apparatus for providing a random early detection (RED) in a packet switched network, the apparatus comprising:
a dequeue counter which is incremented upon each dequeue of a data packet from a queue (Q) and which is reset upon each enqueue of a data packet into the queue;
a coefficient memory table (CMT) which stores a plurality of decay coefficients (C); and
a calculation unit which is adapted to calculate upon each enqueue of a data packet in the Q, an AQS of the Q, depending on a decay coefficient (C), wherein the decay coefficient is read from a memory address of the CMT to which the dequeue counter points before the dequeue counter is reset.

In a first possible implementation of the apparatus according to the first aspect of the present application the calculation unit is adapted to compare the calculated AQS of the Q with a maximum threshold value and a minimum threshold value.

In a further second implementation of the first implementation of the apparatus according to the first aspect of the present application the calculation unit is adapted to drop a received data packet if the AQS exceeds the maximum threshold value.

In a further third implementation of the first or second implementation of the apparatus for providing a RED in a packet switched network according to the first aspect of the present application, the calculation unit is adapted to enqueue the received data packet if the AQS is lower than the minimum threshold value.

In a further fourth implementation of any of the first to third implementation of the apparatus for providing a RED in a packet switched network according to the first aspect of the present application, the calculation unit is adapted to drop the received data packet randomly if the calculated AQS is between the minimum threshold value and the maximum threshold value.

In a further fifth implementation of the fourth implementation of the apparatus for providing a RED in a packet switched network according to the first aspect of the present application, the received data packets are dropped randomly with a different drop probability per traffic priority if the calculated AQS is between the minimum threshold value and the maximum threshold value.

In a sixth implementation of any of the first to fifth implementation of the apparatus for providing a RED in a packet switched network according to the first aspect of the present application, the calculation unit is adapted to calculate the AQS as follows:

[Curr AQS−Queue Size Diff]×C+Queue Size Diff,

wherein Curr AQS is the current AQS,

wherein Queue Size Diff is a queue size difference,

wherein Queue Size Diff=(Prev Queue Size−Curr Queue Size)/2, wherein Prev Queue Size is the previously calculated queue size of the Q,

Curr Queue Size is the currently calculated queue size of the Q,

C is the decay coefficient read from the CMT depending on the pointer value of the dequeue counter of the Q.

In a further seventh implementation of the sixth implementation of the apparatus for providing a RED in a packet switched network according to the first aspect of the present application, the decay coefficients (C) are decay coefficients.

In an eighth implementation of the seventh implementation of the apparatus for providing a RED in a packet switched network according to the first aspect of the present application the precalculated decay coefficients are coefficients of an exponential decay function stored in the CMT.

In a possible ninth implementation of any of the seventh or eighth implementation of the apparatus for providing a RED in a packet switched network according to the first aspect of the present application the calculation unit is adapted to calculate in advance the decay coefficients (C) of the exponential decay function as follows:

x[i+1]=x[i]×(N−W)/N

C[i+1]=(x[i+1]−x[0])/x[0]

wherein x[0] is an arbitrary number, N, W are arbitrary numbers (W<N) and i is a variable.

In a possible tenth implementation of the ninth implementation of the apparatus for providing a RED in a packet switched network according to the first aspect of the present application

x[0] is set to 100,

W is set to 1,

N is set to 256.

The applicant further provides as a second aspect a method for providing a RED in a packet switched network comprising the steps of:
incrementing a dequeue counter upon each dequeue of a data packet from a queue (Q), and resetting the dequeue counter upon each enqueue of a data packet in the Q; and
calculating, upon each enqueue of a data packet in the Q an AQS of the Q, depending on a decay coefficient (C), the decay coefficient is read from a memory address of a CMT to which the dequeue counter points before the dequeue counter is reset.

In a first possible implementation of the method for providing a RED in a packet switched network according to the second aspect of the present application, the method further comprises comparing the calculated AQS of the Q with a maximum threshold value and a minimum threshold value.

In a possible second implementation of the first implementation of the method for providing a RED in a packet switched network according to the second aspect of the present application, the method further comprises dropping a received data packet if the calculated AQS exceeds the maximum threshold value.

In a further possible third implementation of the first or second implementation of the method for providing a RED in a packet switched network according to the second aspect of the present application, the method further comprises enqueuing the received data packet if the calculated AQS is lower than the minimum threshold value.

In a further possible fourth implementation of any of the first to third implementation of the method for providing a RED in a packet switched network according to the second aspect of the present application, the method further comprises dropping randomly the received data packet if the calculated AQS is between the minimum threshold value and the maximum threshold value.

In a further possible fifth implementation of the method for providing a RED in a packet switched network according to the second aspect of the present application, the dropping randomly (S10) the received data packet comprises dropped randomly the received data packets (S10) with a different drop probability per traffic priority.

In a further possible sixth implementation of the method for providing a RED in a packet switched network according to the second aspect of the present application, the method further comprises calculating the AQS of the Q, depending on a decay coefficient (C), as follows:

[Curr AQS−Queue Size Diff]×C+Queue Size Diff,

wherein Curr AQS is the current AQS,

wherein Queue Size Diff is the queue size difference,

wherein Queue Size Diff=(Prev Queue Size−Curr Queue Size)/2,

wherein Prev Queue Size is the previously calculated queue size of the Q,

Curr Queue Size is the currently calculated queue size and C is a decay coefficient read from the CMT depending on the pointer value of the dequeue counter of the Q.

In a further possible seventh implementation of any of the first to sixth implementation of the method for providing a RED in a packet switched network according to the second aspect of the present application the decay coefficients (C), are precalculated decay coefficients.

In a further possible eighth implementation of the seventh implementation of the method for providing a RED in a packet switched network according to the second aspect of the present application the precalculated decay coefficients are decay coefficients of an exponential decay function stored in the CMT.

In a further possible ninth implementation of the method for providing a RED in a packet switched network according to the second aspect of the present application, the method further comprises calculating in advance the decay coefficients (C), of the exponential decay function as follows:

x[i+1]=x[i]×(N−W)/N

C[i+1]=(x[i+1]−x[0])/x[0]

wherein x[0] is an arbitrary number,

wherein N, W are arbitrary numbers (W<N) and i is a variable.

According to a third aspect of the present application, an alternative apparatus for providing a RED in a packet switched network is provided. The apparatus comprises a processor for performing the method according to the second aspect as such or any of the preceding first to ninth implementation forms of the second aspect.

The applicant further provides as a fourth aspect a packet switched network comprising an apparatus according to the first aspect of the present application as such or according to any preceding first to tenth implementation forms of the first aspect, or according to the third aspect of the present application as such.

In a possible implementation of the packet switched network according to the fourth aspect of the present application the network comprises the internet.

According to a fifth aspect, the applicant can be implemented in digital electronic circuitry, or in computer hardware, firmware, computer software, or in combinations thereof. The computer software comprises a program code for performing the method according to the second aspect as such or according any of the preceding first to ninth implementation forms of the second aspect.

These and other aspects of the applicant will be apparent from the embodiment (s) described below.

### BRIEF DESCRIPTION OF THE DRAWINGS

In the following possible embodiments of an apparatus and a method for providing a RED in a packet switched network according to the first, second, third and fourth aspects of the present application are described with reference to the enclosed figures.

FIG. 1 shows a block diagram of a possible implementation of a RED apparatus according to the first aspect of the present application;

FIG. 2 shows a flow chart of a possible implementation of a method for providing a RED in a packet switched network according to the second aspect of the present application; and

FIG. 3 shows a diagram illustrating an average queue size (AQS) of a queue under random data traffic as provided by a conventional RED mechanism in comparison to a RED mechanism as provided by the apparatus and the method according to the present application.

### DETAILED DESCRIPTION

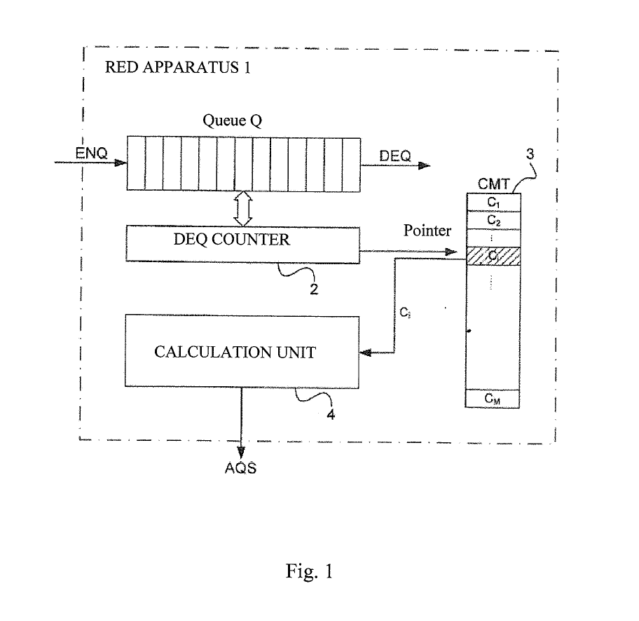

FIG. 1 shows a possible implementation of an apparatus 1 for providing a random early detection (RED) in a packet switched network. The apparatus 1 comprises in the shown implementation a queue (Q) in which data packets can be enqueued (ENQ) and from which data packets can be dequeued (DEQ). The apparatus 1 for providing a random early detection in the packet switched network further comprises a dequeue counter 2 which is incremented upon each dequeue of a data packet from the queue (Q), and which is reset upon each enqueue of a data packet into the queue (Q).

A queue is a particular kind of abstract data type or collection in which the entities in the collection are kept in order. Taking the FIFO queue as an example, the principal (or only) operations on the collection are the addition of entities to the rear terminal position, known as enqueue, and removal of entities from the front terminal position, known as dequeue. This makes the queue a First-In-First-Out (FIFO) data structure.

As can be seen in FIG. 1 the apparatus 1 for providing a RED in a packet switched network comprises in the shown implementation a coefficient memory table (CMT) stored in a memory 3, wherein the CMT stores a predetermined number (M) of decay coefficients (C), as illustrated in FIG. 1.

The apparatus 1 for providing a random early detection (RED) in a packet switched network further comprises a calculation unit 4. The calculation unit 4 is adapted to calculate upon each enqueue of a data packet in the queue (Q) an average queue size (AQS) of the respective queue (Q) depending on a decay coefficient (C) read from a memory address of that coefficient memory table (CMT) to which the dequeue counter 2 points before it is reset. The storage size of the queue (Q) i.e. the number of data packets which can be enqueued in the respective queue of the apparatus 1 can vary depending on the application of the apparatus 1. Further, the data packets stored in a queue (Q) of the apparatus 1 can also have a different data packet size and can comprise data packets of different types and/or data protocols. The apparatus 1 for providing a RED in a packet switched network can form part of a more complex apparatus or machine such as a router in a packet switched network. Each port of such a router can have different queues (Q) wherein each queue can be assigned in a possible implementation to an input data stream coming for example from a client. Such a client can be connected via a link to a port of the respective router comprising the apparatus 1 for providing a RED in the packet switched network as shown in FIG. 1. In a possible implementation each client can have its own queue (Q) within the apparatus 1. In a possible implementation the calculation unit 4 can output the calculated AQS of the respective queue (Q) for further processing.

In a further possible implementation of the apparatus 1 for providing a RED in a packet switched network the calculation unit 4 is further adapted to compare the calculated AQS of the respective queue (Q) with a predetermined maximum threshold value and a predetermined minimum threshold value. In a possible implementation the maximum threshold value as well as the minimum threshold value is adaptable for different applications of the apparatus 1. In a possible implementation the calculation unit 4 can drop a received data packet for the respective queue (Q) if the calculated AQS exceeds the maximum threshold value. On the contrary, the calculation unit does enqueue a received data packet into the respective queue (Q) if the calculated AQS is lower than the minimum threshold value. In a further possible implementation the calculation unit is adapted to drop the received data packet randomly if the calculated AQS is between the minimum threshold value and the maximum threshold value. In a possible specific implementation of the apparatus 1 for providing a RED of a packet switched network according to the first aspect of the present application the calculation unit 4 is adapted to calculate the AQS, also called a next average queue size (NEXT AQS) as follows:

NEXT AQS=[Curr AQS−Queue Size Diff]×C+Queue Size Diff,

wherein Curr AQS is the current average queue size (AQS),

wherein Queue Size Diff is the queue size difference,

wherein Queue Size Diff=(Prev Queue Size−Curr Queue Size)/2,

wherein Prev Queue Size is the previously calculated queue size of the respective queue (Q),

Curr Queue Size is the currently calculated queue size of the respective queue (Q),

C is a decay coefficient read from the CMT depending on the pointer value of the dequeue counter 2 of the respective queue (Q).

The decay coefficient (C) stored in the memory 3 can be in a possible implementation precalculated decay coefficients of an exponential decay function stored in the CMT. In a possible implementation the decay functions (C) stored in the memory 3 within the CMT, are precalculated and can be configurable. In a possible embodiment the calculation unit 4 of the apparatus 1 is adapted to calculate in advance the decay coefficients (C) of the exponential decay function stored in the memory 3 of the apparatus 1 as follows:

x[i+1]=x[i]×(N−W)/N

C[i+1]=(x[i+1]−x[0])/x[0]

wherein x[0] is an arbitrary number, N, W are arbitrary numbers (W<N) and i is a variable.

In a possible exemplary implementation the values are such as follows:

x[0] is set to 100,

W is set to 1,

N is set to 256.

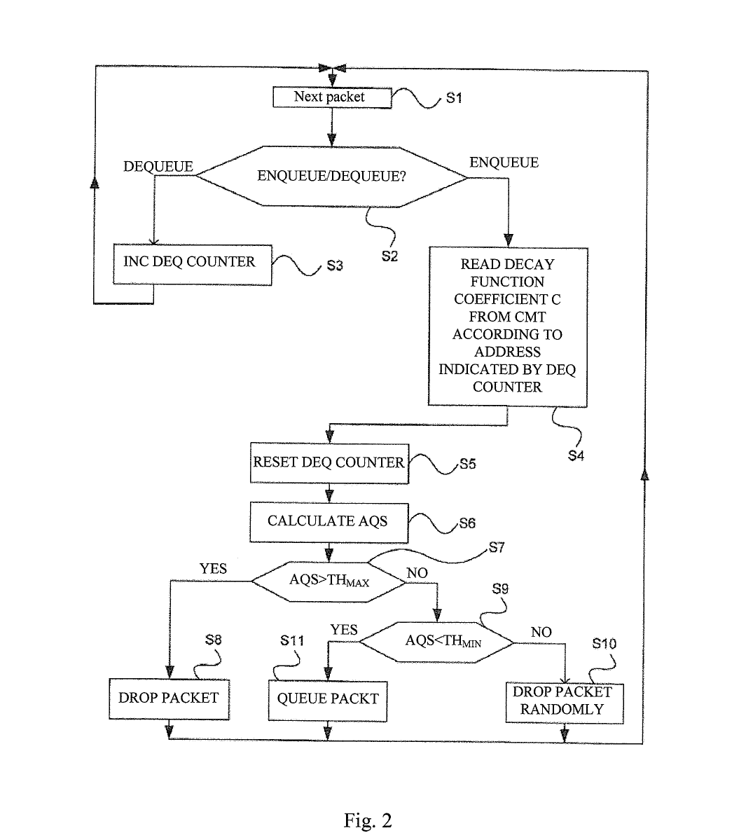

FIG. 2 shows a flow chart of a possible implementation of a method for providing a random early detection (RED) in a packet switched network according to the second aspect of the present application.

As can be seen in FIG. 2 in step S1 a next data packet is to be processed with the respective queue (Q). In a further step S2 it is decided whether the data packet has to be enqueued in the respective queue (Q) or has to be dequeued from the respective queue (Q). If the data packet is dequeued, the dequeue counter 2 of the RED apparatus 1 is incremented in step S3 as shown in FIG. 2. On the other hand, if the data packet is enqueued into the respective queue (Q), a decay coefficient (also known as a decay function coefficient) is read from the CMT according to an address indicated by the dequeue counter value in step S4 as shown in FIG. 2. After having read the decay coefficient from the CMT in step S4 the dequeue counter 2 of the apparatus 1 is reset in step S5. In step S6 the AQS of the respective queue (Q) is calculated. Further, in a possible implementation the calculation equation is as follows:

NEXT AQS=[Curr AQS−Queue Size Diff]×C+Queue Size Diff,

wherein NEXT AQS is the AQS currently being calculated,

wherein Curr AQS is the current AQS,

wherein Queue Size Diff is the queue size difference,

wherein Queue Size Diff=(Prev Queue Size−Curr Queue Size)/2,

wherein Prev Queue Size is the previously calculated queue size of the respective queue (Q),

Curr Queue Size is the currently calculated queue size and

C is a decay coefficient read from the CMT depending on the pointer value of the dequeue counter 2 of the respective queue (Q) in step S4.

The performing of steps S5 and S6 does not have the sequence requirement, they may be performed in parallel, or one after the other. Only as an example the step S5 is performed before the step S6 in FIG. 2.

In a further step S7 the calculated AQS is compared with a predetermined maximum threshold value (TH_{MAX}) and the data packet is dropped in step S8 if the AQS exceeds the predetermined maximum threshold value. If the calculated AQS of the respective queue (Q) is smaller than the maximum threshold value THₘₐₓ the calculated AQS is compared in step S9 with the minimum threshold value THₘᵢₙ. If the calculated AQS exceeds the minimum threshold value THₘᵢₙ, i.e. lies in a range between the minimum threshold value and the maximum threshold value the received data packet is dropped randomly in step S10. On the contrary, if the calculated AQS is also lower than the minimum threshold value THₘᵢₙ the data packet is enqueued in step S11 as shown in FIG. 2.

The calculation mechanism as shown in the implementation of FIG. 2 does not only perform iteration for enqueues, i.e. input data packets, but also takes into consideration the dequeues of data packets (output packets). Accordingly, the calculation mechanism shown in FIG. 2 does not simply add iterations for dequeues, thus doubling the number of calculations and the bandwidth needed to read the current AQS and queue size values. To avoid this penalty the calculation method as shown in the implementation of FIG. 2 performs the calculation only for enqueues but the effect of the number of dequeues is approximated using the CMT. The method according to the present application uses a dequeue counter 2 that is incremented per each dequeue and which is reset in step S5 when an enqueue is encountered. This dequeue counter 2 expresses the number of dequeues since the last enqueue of a data packet in the queue (Q). If an enqueue is encountered a coefficient (C) is read from the CMT. The CMT can be based on an exponential decay function wherein the decay coefficients C are precalculated, i.e. calculated once in advance. Each decay coefficient (C) is stored at a memory address of the memory 3 as shown in FIG. 1. The value of the dequeue counter 2 operates as a pointer for selecting a memory address where the decay function coefficiency is stored. The number M of the decay coefficients (C) which are stored in the memory 3 can vary. For example, the number M of the decay coefficients (C) stored in the memory 3 can comprise 1000 exponential decay coefficients (C). Upon each reset performed in step S5 the dequeue counter 2 is set back to the first coefficient C1 stored in the CMT of the memory 3. Upon each dequeue of a data packet from the respective queue (Q), the dequeue counter 2 is incremented in step S3 and points to the next memory address where the next coefficients (C) is stored. For example, if ten dequeue operations are encountered in a row, the dequeue counter 2 is incremented ten times and points to the tenth coefficient C₁₀ stored in the CMT. With the method as shown in FIG. 2 a random early detection (RED) is performed to avoid traffic data congestion. The calculation of the AQS according to the method of the present application as shown in the implementation of FIG. 2 takes into account an input function of the data but also an output function. In considering both, input and output function the method according to the present application results in a better AQS overall. This can be achieved while keeping the calculation overhead small and by continuing to perform the calculation on the received data packets only. The determined AQS does enhance the ability of the apparatus 1 to predict data congestion and results in a better data congestion avoidance in the packet switched network.

According to another embodiment the method shown in FIG. 2 can be implemented in digital electronic circuitry, or in computer hardware, firmware, computer software, or in combinations thereof. The computer software comprises a program code for performing the method as shown in FIG. 2.

According to another embodiment the present application, an alternative apparatus for providing a random early detection in a packet switched network is provided. The apparatus may comprise a processor for performing the method as shown in FIG. 2.

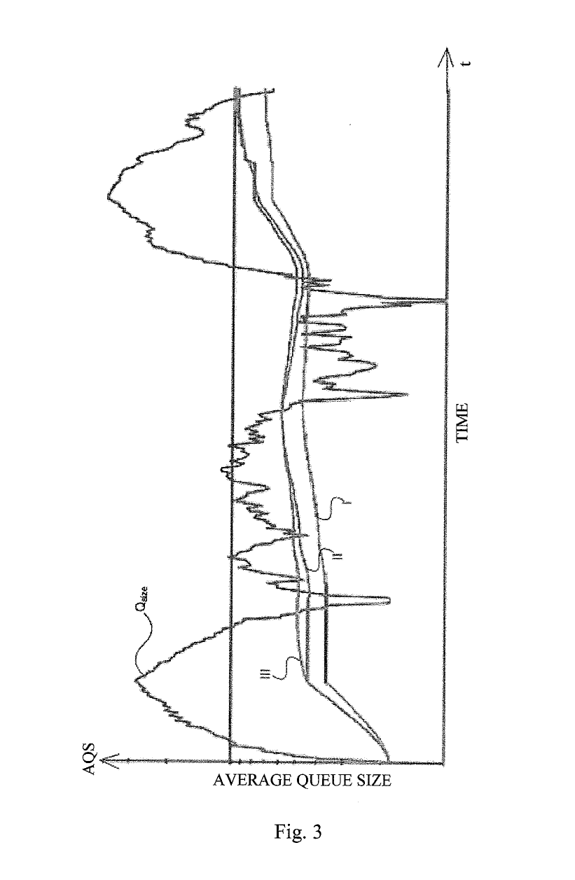

FIG. 3 shows a diagram for illustrating the calculated AQS under random data traffic over time. As can be seen in FIG. 3 the method for providing a random early detection (RED) in a packet switched network according to the present application does show better accuracy and tracking for the AQS. Curve I illustrates a conventional RED mechanism wherein the AQS is only calculated for enqueues. The second curve II is the calculated AQS calculated by the method according to the present application which calculates the AQS for enqueues with an approximation for dequeues. The third curve III shows an optimal calculation for both, enqueue and dequeue of data packets. As can be seen from FIG. 3 the calculation of the AQS as performed by the present application (curve II) is more accurate than the calculation of the AQS with the conventional method for RED (curve I) since its curve is much closer to the optimal curve III.

Flat lines indicate time periods without enqueue thus the AQS remains at the last enqueue value. The AQS value may continue to rise even during dequeue only periods because the queue size is greater than the AQS. The AQS may continue to descend even during an enqueue only period because the queue size is smaller than the AQS.

In a possible implementation of the method according to the present application, the received data packets are dropped randomly with a different drop probability per traffic priority if the calculated AQS is between the minimum threshold value and the maximum threshold value. In this implementation a weighted random early detection (WRED) is performed. Data traffic having a higher traffic priority has less probability for data packets to be dropped by the mechanism.

Ina further possible implementation the response to a packet drop a protocol, such as a TCP protocol, can decrease a transmission rate so that traffic congestion is avoided. The method for providing a random early detection (RED) in a packet switched network can be used in a wide range of applications and networks, in particular in the internet in collaboration with the TCP protocol. The improved method for providing a RED in a packet switched network according to the present application can increase the bandwidth efficiency of the network by preserving the properties of congestion avoidance. The method for providing a RED in a packet switched network can be used by any router or other communication equipment that uses RED to improve the performance of the respective router or communication equipment.

What is claimed is:

1. An apparatus for providing a random early detection (RED) in a packet switched network, the apparatus comprising:
a dequeue counter which is incremented upon each dequeue of a data packet from a queue (Q) and which is reset upon each enqueue of a data packet into the Q;
a coefficient memory table (CMT) which stores plurality of decay coefficients (C); and
a calculation unit which is configured to calculate, upon each enqueue of a data packet in the Q, an average queue size (AQS) of the Q, depending on a decay coefficient C, wherein the decay coefficient is read from a memory address of the CMT to which the dequeue counter points before the dequeue counter is reset.

2. The apparatus according to claim 1, wherein the calculation unit is configured to compare the calculated AQS of the Q, with a maximum threshold value and a minimum threshold value to drop a received data packet if the AQS, exceeds the maximum threshold value, to enqueue the received data packet if the AQS is lower than the minimum threshold value and to drop the received data packet randomly if the calculated AQS is between the minimum threshold value and the maximum threshold value.

3. The apparatus according to claim 2, wherein the received data packets are dropped randomly with a different drop probability per traffic priority if the calculated AQS is between the minimum threshold value and the maximum threshold value.

4. The apparatus according to claim 1, wherein the calculation unit is adapted to calculate the AQS of the queue Q, as follows:
[Curr AQS−Queue Size Diff]×C+Queue Size Diff,
wherein Curr AQS is the current AQS,
wherein
Queue Size Diff is a queue size difference,
wherein
Queue Size Diff=(Prev Queue Size−Curr Queue Size)/2,
wherein Prev Queue Size is the previously calculated queue size of the queue (Q),
Curr Queue Size is the currently calculated queue size of the queue (Q),
C is the decay coefficient read from the CMT, depending on the pointer value of the dequeue counter of the Q.

5. The apparatus according to claim 1, wherein the decay coefficients (C) are decay coefficients of an exponential decay function stored in the CMT.

6. The apparatus according to claim 5, wherein the calculation unit is adapted to calculate in advance the decay coefficients (C) of the exponential decay function as follows:
x[i+1]=x[i]×(N−W)/N
C[i+1]=(x[i+1]−x[0])/x[0]
wherein x[0] is an arbitrary number, N, W are arbitrary numbers (W<N) and i is a variable.

7. The apparatus according to claim 6, wherein
x[0] is set to 100,
W is set to 1,
N is set to 256.

8. A method for providing a random early detection (RED) in a packet switched network, comprising:
incrementing a dequeue counter upon each dequeue of a data packet from a queue (Q), and resetting the dequeue counter upon each enqueue of a data packet in the Q; and
calculating, upon each enqueue of a data packet in the Q, an average queue size (AQS) of the Q, depending on a decay coefficient (C), wherein the decay coefficient is read from a memory address of a coefficient memory table (CMT) to which the dequeue counterpoints before the dequeue counter is reset.

9. The method according to claim 8, wherein the method further comprises comparing the calculated AQS of the Q, with a maximum threshold value and a minimum threshold value;
dropping a received data packet if the calculated AQS exceeds the maximum threshold value, enqueuing the received data packet if the calculated AQS is lower than the minimum threshold value and dropping randomly the received data packet if the calculated AQS is between the minimum threshold value and the maximum threshold value.

10. The method according to claim 9, wherein the dropping randomly the received data packet comprises dropped randomly the received data packets with a different drop probability per traffic priority.

11. The method according to claim 8,
wherein calculating the AQS of the Q, depending on a decay coefficient (C), as follows:
[Curr AQS−Queue Size Diff]×C+Queue Size Diff,
wherein Curr AQS is the current AQS, wherein
Queue Size Diff is the queue size difference, wherein Queue Size Diff=(Prev Queue Size−Curr Queue Size)/2, wherein Prev Queue Size is the previously calculated queue size of the Q, Curr Queue Size is the currently calculated queue size and C is the decay coefficient read from the CMT, depending on the pointer value of the dequeue counter of the Q.

12. The method according to claim 8, wherein the decay coefficients (C) are decay coefficients of an exponential decay function stored in the CMT.

13. The method according to claim 8, wherein the method further comprises calculating in advance the decay coefficient (C) of the exponential decay function as follows:
x[i+1]=x[i]×(N−W)/N
C[i+1]=(x[i+1]−x[0])/x[0]
wherein x[0] is an arbitrary number,
wherein N, W are arbitrary numbers (W<N) and i is a variable.
